(19) United States
(12) Patent Application Publication
(10) Pub. No.: US 2010/0161418 A1
(43) Pub. Date: Jun. 24, 2010

(54) Media Distribution Systems and Methods

(76) Inventors: Michael J. F. Holt, Colorado Springs, CO (US); Julie A. Grabow, Colorado Springs, CO (US)

Correspondence Address: ADVANTIA LAW GROUP, 9035 SOUTH 1300 EAST, SUITE 200, SANDY, UT, 84094, US

(21) Appl. No.: 12/338,683

(22) Filed: Dec. 18, 2008

(51) Int. Cl. G06Q 30/00

(52) U.S. Cl. 705/14.55; 705/14.66

(57) ABSTRACT

A media distribution system for providing advertising comprising a network; wherein the media distribution system includes a media distribution device in communication with the network, wherein the media distribution device includes a personal computing device having a first display module. The personal computing device includes a second display module coupled to the personal computing device, disposed opposite the first display module and oriented in a substantially opposite direction from the first display module. The second display module may be pivotly coupled to the first display module. The media distribution system further includes an advertisement control module in communication with a plurality of media distribution devices over the network; wherein the advertisement control module is configured to control display of advertisements over the plurality of media distribution devices.

### BACKGROUND OF THE INVENTION

1. Field of the Invention

The present invention relates to media distribution systems and methods for providing advertising, specifically to systems and methods including use of dual-screen computing devices.

2. Description of the Related Art

Advertising is a critical part of our economy. Through advertising, industry is able to leverage the buying power of millions to create and distribute goods and services at ever decreasing cost. Accordingly, innovations in advertising provide a multiplying effect on the economy. With such benefits to be had, constant effort is made towards enhancing and innovating methods and systems of advertising.

Branding is one means of advertising that has been long used. By placing one's mark on a product, the product becomes an unrelenting source of advertising. In this regard, computer manufacturers have traditionally placed a design logo on their computers to help with advertising. The design logos have typically been placed about a side opposite of the computer screen; so when the computer is in use, the design logo is visibly displayed. However, the design logo is limited in applicability and generally not targeted. Some improvements have been made in the field. Examples of references related to the present invention are described below, and the supported teachings of each reference are incorporated by reference herein:

U.S. Pat. No. 6,667,878, issued to Ponx, discloses a laptop or notebook computer which employs first and second display screens coupled electronically to display identical images at the same time. The dual screen capability is ideal for business presentations, instruction and other like uses. The two screens are mechanically coupled to each other and to the computer in a manner which allows the three elements to be collapsed into a compact unit. A cover is provided to protect the second screen. The cover functions as the top of the computer when the unit is collapsed. The cover may be hinged to the second screen or may be designed to slide off.

U.S. Pat. No. 6,295,038, issued to Rebeske, discloses a laptop computer is constructed having a case including a keyboard and containing traditional computer components. A display screen is hingedly secured to the computer case and may be pivoted about the hinge to an operative position wherein an operator can observe the information displayed on the display screen. A second display screen is hingedly secured to the first display screen and is also connected to the computer components within the computer case. The second display screen, when hinged to its operative position displays the same information displayed on the first display screen, but is directed in an opposite direction to permit an operator and an observer to observe the same information viewable on the first and second display screens, respectively.

U.S. Pat. No. 5,467,102, issued to Kuno, discloses a portable display device capable of presenting a document in an easy to read format, in which a simultaneous display of different parts of the document in reasonable sizes can be made, by a simple operation of the device. The display device comprises a document memory for storing documents to be displayed, at least two display screens for displaying the documents stored in the document memory means, and a display control unit for controlling displays of the documents on the display screens to be in a linked mode in which the displays on the display screens are linked together and in a separate mode in which the displays on the display screens are independent from each other.

U.S. Pat. No. 5,796,577, issued to Ouchi et al., discloses a notebook computer 1 comprises a keyboard 2 positioned on the upper surface of a computer body 10, an operating ball 22, function keys 24 and the like. A cover member fixed to the computer body 10 by a hinge 40 so that it opens and closes against the computer body is supported in an open position substantially perpendicular to the body 10. A first display device 60 is formed on the inner surface of the cover member 50, and a second display device 70 is formed on the outer surface thereof. The operator and the client facing each other with the notebook computer positioned between them could share the same screen information by watching each of the two display devices in front of them.

U.S. Pat. No. 6,430,603, issued to Hunter, discloses commercial advertisers, such as consumer product companies and the advertising agents that represent them, directly access a network of thousands of large, high resolution electronic displays located in high traffic areas and directly send their own advertisements electronically to the network to be displayed at locations and times selected by the advertisers.

U.S. Pat. No. 7,107,346, issued to Boyd, discloses a system and method are disclosed for distributing and presenting preferred data from a host server to a display device located at a predetermined remote premise through a communications network. The method involves identifying a user preference, providing at least one data feed containing information related to the user preference, selecting preferred data from the data feed corresponding to the user preference, pre-loading information that matches the preferred data from the host server to the display device, and presenting the preferred data through the display device.

The inventions heretofore known suffer from a number of disadvantages which include being difficult to use, being expensive, being unduly complicated, being limited in adaptability, being limited in application, being limited in versatility, and being impractical.

What is needed is a media distribution system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by a currently available media distribution system. Accordingly, the present invention has been developed to provide a dual screen laptop business method.

In one embodiment of the invention, there is a media distribution system for providing advertising comprising a network. The media distribution system may also include a media distribution device in communication with the network, wherein the media distribution device includes a personal computing device having a first display. The personal computing device may also include a second display coupled to the personal computing device, disposed opposite the first display and oriented in a substantially opposite direction from the first display. The second display module may be pivotly coupled to the first display module. The media distribution system may further include an advertisement control module in communication with a plurality of media distribution devices over the network; wherein the advertisement control module may be configured to control display of advertisements over the plurality of media distribution devices.

The media distribution device may also include a sensor module configured to detect a characteristic and report the state of the characteristic over the network. The sensor module may be selected from the group of modules consisting of a GPS module, a power module, a proximity module, an IR module, and a wireless module. The media distribution device may further include a communication module configured to provide information regarding the second display over the network. In addition, the media distribution device may include a GPS module, an IR detection module, a memory module, and a sensor module in communication with the network.

In one embodiment of the invention, there is a method of distributing advertising over a network, wherein the method may provide a network of media distribution devices including a personal computing devices having first and second displays. Then, the method may include distributing media information over the network including information configured to be displayed on the second display of a media distribution device. Then, providing a media information control module configured to control the display on the second display of a media distribution device. The method may also include receiving information from a media distribution device regarding a characteristic related to display of the media information.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of a media distribution system, according to one embodiment of the invention;

FIG. 2 is a dual-screen laptop of a media distribution system, according to one embodiment of the invention;

FIG. 3 is network diagram of a media distribution system, according to one embodiment of the invention;

FIG. 4 is a flowchart of a method of distribution, according to one embodiment of the invention; and

FIG. 5 is a block diagram of a media display module of a media distribution system, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will, nevertheless, be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

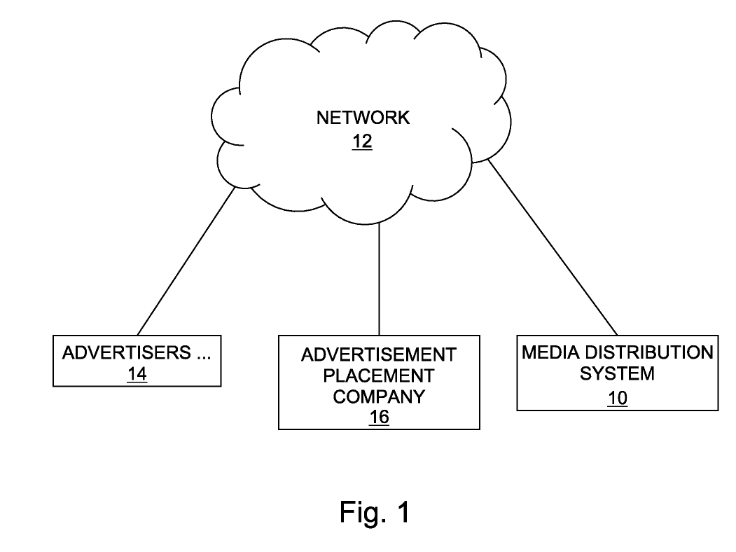

FIG. 1 is a network diagram of a media distribution system 10, according to one embodiment of the invention; wherein the media distribution system 10 is in communication with a network 12. The network 12 is in communication with a plurality of advertisers 14; wherein the advertisers 14 display a product or service that the advertisers provide over the network 12. The network 12 is also in communication with an advertisement placement company 16; wherein the advertisers are in communication with the advertisement placement company 16 over the network. The advertisement placement company 16 is configured to display the advertisers' product or service through the network 12 on the media distribution system 10.

In operation of one embodiment of the invention, an advertiser contacts an placement service through the network; wherein the advertiser wants to display a product or service they provide to the public. The advertising placement service describes the various methods of displaying their advertisement over the media distribution system. The advertiser then decides which demographic, area, and time period they would like the advertisement to be displayed. Then the advertisement placement service contacts the media distribution system; wherein the media distribution system is configured to display the advertisement for a particular demographic, area, and period of time.

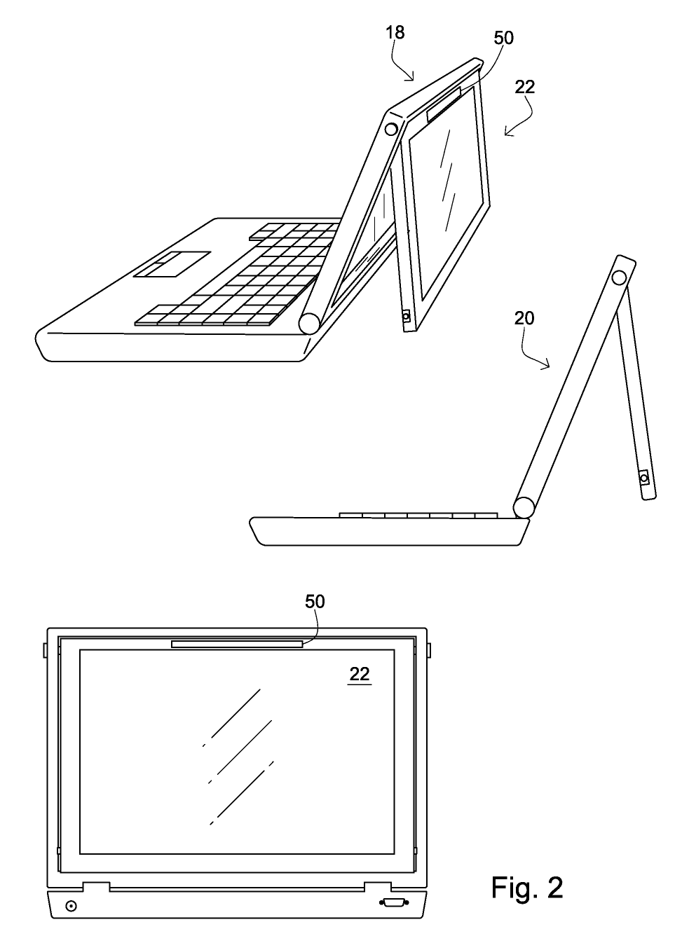

FIG. 2 is a dual-screen laptop 18 of a media distribution system 10, according to one embodiment of the invention; wherein the media distribution system 10 includes a dual-screen laptop 18 in communication with the network, wherein the dual-screen laptop 18 includes a first display module 20. The dual-screen laptop 18 also includes a second display module 22 coupled to the laptop 18, disposed opposite the first display module 20 and oriented in a substantially opposite direction from the first display module 20. The second display module 22 is configured to pivotly couple to the first display module 20. The second display module 22 is configured to pivot because when a user is using the laptop 18 and viewing the first display module 20, the second display module 22 is often difficult to view. Thereby pivoting the second display module 22 enables other viewers to clearly view the advertisement disposed about the second display module 22, without interrupting the view of the first display module by the user. FIG. 2 also illustrates a sensor module 50 configured to detect a characteristic and report the state of the characteristic over the network. The sensor module 50 is selected from the group of modules consisting of a GPS module, a power module, a proximity module, an IR module, and a communication module.

In operation of one embodiment of the invention, an advertiser contacts an advertisement placement company through the network; wherein the advertiser wants to display a product or service they provide to the public. Then the advertisement placement company contacts the media distribution system; wherein the media distribution system is configured to display the advertisement for a particular demographic, area, and period of time. The media distribution system displays the advertisements on the second display module of the dual-screen laptop.

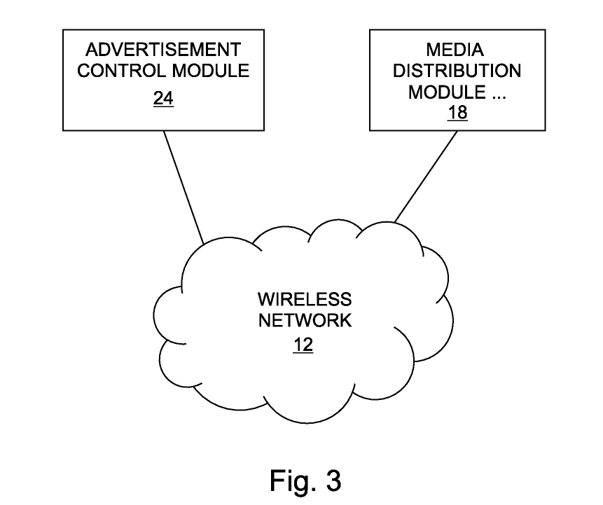

FIG. 3 is network diagram of a media distribution system 10, according to one embodiment of the invention; wherein the media distribution system 10 includes a an advertisement control module 24 in communication with a plurality of media distribution devices 18 over the network 12 wherein the advertisement control module 24 is configured to control display of advertisements over the plurality of media distribution devices 18. The advertisement control module 24 is configured to sort, filter, and organize characteristics from the media distribution system 10 to assist in effective advertising. A non-limiting example of a media distribution device may be a dual screen laptop.

In operation of one embodiment of the invention, an advertiser contacts an advertisement placement company through the network; wherein the advertiser wants to display a product or service they provide to the public. Then the advertisement placement company contacts the media distribution system; wherein the media distribution system is configured to display the advertisement for a particular demographic, area, and period of time. The media distribution system displays the advertisements on the second display module of the dual-screen laptop; wherein the advertisements are controlled by an advertisement control module. The advertisement control module is configured to determine the demographic, area, and period of time the advertisement will display about the media distribution system. In addition, the advertisers and/or the advertisement placement company may set parameters regarding their advertisements that the advertisement control module follows. Furthermore, the media distribution system may include a plurality of media distribution modules to display advertisements.

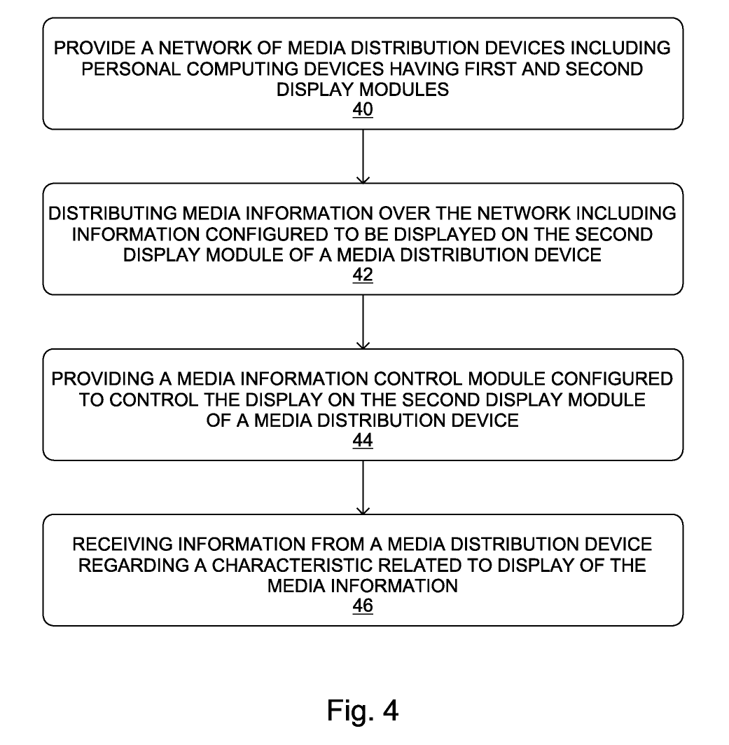

FIG. 4 is a flowchart of a method of distributing advertising over a network, according to one embodiment of the invention; wherein the method of distributing advertising over a network includes providing a network of media distribution devices including personal computing devices having first and second display modules 40. Then the method includes distributing media information over the network including information configured to be displayed on the second display module of a media distribution device 42. The method then includes providing a media information control module configured to control the display on the second display module of a media distribution device 44. Furthermore, the method includes receiving information from a media distribution device regarding a characteristic related to display of the media information 46.

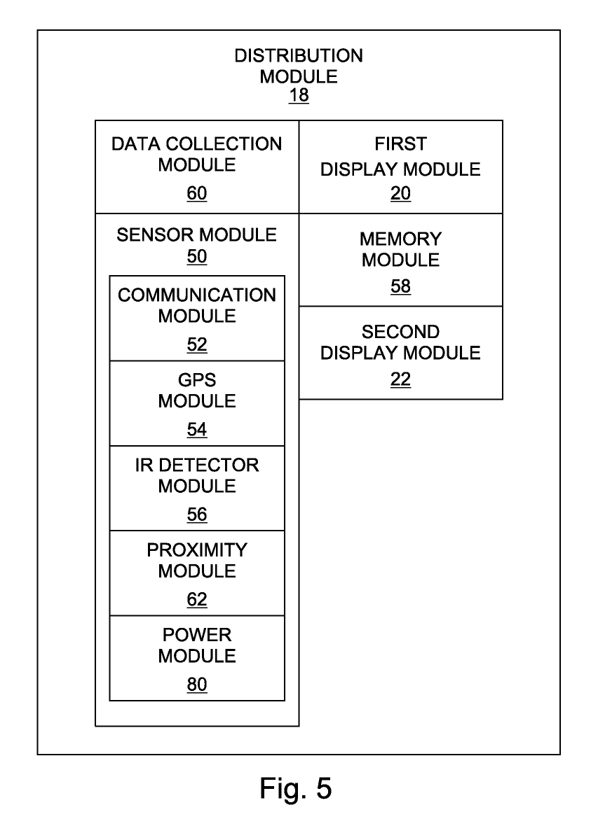

FIG. 5 is a block diagram of a media distribution module 18 of a media distribution system 10, according to one embodiment of the invention; wherein the media distribution module 18 includes a sensor module 50 configured to detect a characteristic and report the state of the characteristic over the network. Non-limiting examples of such characteristics include: location, time, temperature, sound, light, mode, object proximity, orientation, and the like. The sensor module 50 includes a communication module 52 configured to provide information regarding the second display module 22 over the network. In addition, the illustrated sensor module 50 also includes a GPS module 54 in communication with the network; wherein the GPS module 54 is configured to provide the location of the media distribution module 18 over the network. The illustrated sensor module 18 further includes an IR detector module 56; wherein the IR detector module 56 is configured to detect heat about the second display module 22 of the media distribution module 18 over the network. Furthermore, the sensor module 50 includes a power module 80; wherein the power module 80 is configured to detect if the power of the media distribution module 18 is turned on. The media distribution module 18 also includes a memory module 58 in communication with the network; wherein the memory module 58 is configured to store characteristics and report the state of the characteristics over the network.

It is envisioned that the media distribution module 18 includes a data collection module 60, wherein the data collection module 60 is in communication with the advertisement control module. The data collection module 60 is configured to store pertinent characteristics regarding the sensor module 50, the GPS module 54, and the IR detector module 56. It is also envisioned that the sensor module 50 also includes a proximity module 62; wherein the proximity module 62 is configured to detect proximity of viewers viewing the second display module 22.

In operation of one embodiment of the invention, an advertiser contacts an advertisement placement company through the network; wherein the advertiser wants to display a product or service they provide to the public. Then the advertisement placement company contacts the media distribution system; wherein the media distribution system is configured to display the advertisement for a particular demographic, area, and period of time. The media distribution system displays the advertisements on the second display module of the dual-screen laptop; wherein the advertisements are controlled by an advertisement control module. The advertisement control module is configured to determine the demographic, area, and period of time the advertisement will display about the media distribution system. In addition, the advertisers and/or the advertisement placement company may set parameters regarding their advertisements that the advertisement control module follows. The parameters may be set in regards to the sensor module, the GPS module, and the IR detector module. The sensor module is configured to detect a characteristic, such as motion in front of the second display module and the amount of other active media distribution modules about a particular area. The GPS module is configured to detect the location of the media display module and how much traffic that location receives. The IR detector module is configured to detect heat about the media distribution module, thereby determining if someone is close enough to view the advertisement displayed about the second display module.

It is envisioned that the media distribution module 18 may be configured to display spreadsheets, internet searches, e-mail review, product presentation, product advertising, power-point presentations, movies, product photo about either display module and still perform its intended function. One non-limiting example may be a user watching a Disney DVD including a popular character on the first display module; wherein an advertisement for the Disney DVD including the Disney character would be displaying on the second display module.

Another non-limiting example may be, an instructor displaying a power-point presentation on the second display module while the instructor is recording comments and notes on a spreadsheet being displayed on the first display module. Furthermore, another non-limiting example may be a user performing an internet search for a product such as a television. While viewing a particular brand of television on the first display module, the advertisement control module would be configured to display an advertisement for that brand of television on the second display module. It is also envisioned that this may be incorporated into a variety of products and services; wherein the user is viewing a product on the first display module and an advertisement is being displayed about the second display module.

In yet another non-limiting example, the second display module may be configured to be coupled to a flat screen computer monitor. The flat screen monitor may be disposed in a waiting room of a hospital or clinic, wherein the flat screen monitor is configured to update and check in patients. While the hospital or clinic attendant checks in the patient, the second display module may be displaying an advertisement for a medical or pharmaceutical product or service available at the hospital or clinic. In addition, the monitor may be disposed in a waiting room, or service department at a car dealership or mechanic's garage, wherein the second display module may be configured to display advertisements for automotive products or services available at the dealership or mechanic's garage while the customer is checking in with the mechanic to have their car serviced.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate a second display module disposed about a side opposite the first display module, one skilled in the art would appreciate that the second display module may be disposed about a plurality of sides of the media distribution module and still perform its intended function.

Additionally, although the figures illustrate an advertisement placement company, one skilled in the art would appreciate that there may be a plurality of advertisement placement companies in communication over the network and configured to display advertisements over the network through the media distribution system.

It is also envisioned that second display module may vary in size, shape, configuration, design, and still perform its intended function.

It is expected that there could be numerous variations of the design of this invention. An example is that the sensor module may include one or more of the sensory devices described herein and that content provided may depend on one or more detected states.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to, consist of, or to consist essentially of, one or more of the features, functions, structures, methods described herein.

What is claimed is:

1. A media distribution system for providing advertising, comprising:
a) a network;
b) a media distribution device in communication with the network, wherein the media distribution device includes:
1) a personal computing device having a first display module;
2) a second display module coupled to the personal computing device, disposed opposite the first display module and oriented in a substantially opposite direction from the first display module.

2. The system of claim 1, further including an advertisement control module in communication with a plurality of media distribution devices over the network wherein the advertisement control module is configured to control display of advertisements over the plurality of media distribution devices.

3. The system of claim 1, wherein the second display module is pivotly coupled to the first display module.

4. The system of claim 1, wherein the media distribution device further includes a sensor module configured to detect a characteristic and report the state of the characteristic over the network.

5. The system of claim 4, wherein the sensor module is selected from the group of modules consisting of GPS module, power module, proximity module, IR module, and wireless module.

6. The system of claim 2, wherein the media distribution device further includes a communication module configured to provide information regarding the second display module over the network.

7. The system of claim 2, wherein the media distribution device further includes a GPS module in communication with the network; wherein the GPS module is configured to provide the location of the media distribution device over the network.

8. The system of claim 2, wherein the media distribution device further includes a IR detector module; wherein the IR detector module is configured to detect heat about the second display module of the media distribution device over the network.

9. The system of claim 2, wherein the media distribution device further includes a memory module in communication with the network; wherein the memory module is configured to store characteristics and report the state of the characteristics over the network.

10. A media distribution system for providing advertising having a network, comprising:
a media distribution device in communication with the network, wherein the media distribution device includes:
1) a personal computing device having a first display module;
2) a second display module coupled to the personal computing device, disposed opposite the first display module and oriented in a substantially opposite direction from the first display module.

11. The system of claim 10, further including an advertisement control module in communication with a plurality of media distribution devices over the network wherein the advertisement control module is configured to control display of advertisements over the plurality of media distribution devices.

12. The system of claim 11, wherein the second display module is pivotly coupled to the first display module.

13. The system of claim 12, wherein the media distribution device further includes a sensor module configured to detect a characteristic and report the state of the characteristic over the network.

14. The system of claim 13, wherein the sensor module is selected from the group of modules consisting of GPS module, power module, proximity module, IR module, and wireless module.

15. The system of claim 14, wherein the media distribution device further includes a communication module configured to provide information regarding the second display module over the network.

16. The system of claim 15, wherein the media distribution device further includes a GPS module in communication with the network; wherein the GPS module is configured to provide the location of the media distribution device over the network.

17. The system of claim 16, wherein the media distribution device further includes a IR detector module; wherein the IR detector module is configured to detect heat about the second display module of the media distribution device over the network.

18. The system of claim 17, wherein the media distribution device further includes a memory module in communication with the network; wherein the memory module is configured to store characteristics and report the state of the characteristics over the network.

19. A method of distributing advertising over a network, comprising:
a) providing a network of media distribution devices including personal computing devices having first and second display modules;
b) distributing media information over the network including information configured to be displayed on the second display module of a media distribution device;
c) providing a media information control module configured to control the display on the second display module of a media distribution device; and
d) receiving information from a media distribution device regarding a characteristic related to display of the media information.
